(19) United States
(12) Patent Application Publication
(10) Pub. No.: US 2011/0234637 A1
(43) Pub. Date: Sep. 29, 2011

(54) SMART GESTURES FOR DIAGRAM STATE TRANSITIONS

(75) Inventors: Stephen M. Danton, Seattle, WA (US); Randy S. Kimmerly, Woodinville, WA (US); Noaa Avital, Seattle, WA (US); Pedro Ardila, Seattle, WA (US); James Randall Flynn, Seattle, WA (US); Arwen E. Pond, Woodinville, WA (US); Laurent Mollicone, Kirkland, WA (US)

(73) Assignee: Microsoft Corporation, Redmond, WA (US)

(21) Appl. No.: 12/731,047

(22) Filed: Mar. 24, 2010

(51) Int. Cl. G09G 5/00; G06F 3/01

(52) U.S. Cl. 345/661; 345/156; 715/863

(57) ABSTRACT

The present invention extends to methods, systems, and computer program products for smart gestures for diagram state transitions. Embodiments of the invention expose a set of gestures and behaviors, which permit diagram transitions to be made with a reduced number of (and potentially a single) user gesture(s). For example, zoom levels can be toggled between a working zoom level and a zoom level sufficient to present an entire diagram and vice versa using a single user input gesture. Likewise, diagrams can be appropriately (and automatically) panned to make selected as well as newly created diagram elements visible in their entirety using a single user input gesture.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

For example, diagramming applications can be used to generate flow charts, organization charts, workflow diagrams, etc. Most diagramming applications include at least a toolbar and a canvas area. A user can pull shapes (e.g., circles, rectangles, squares, diamonds, etc.) from the tool bar to add to the canvas. Shapes can be connected to one another to indicate relationships between the shapes. Diagramming applications typically also permit a user to select, rearrange and remove existing shapes and connections, change zoom levels, move between different portions of a diagram (e.g., panning), etc.

For example, some diagramming applications permit canvas areas that are larger than the displayable area of a display device. Thus, from time to time, a user may need to move from a portion of a diagram that is currently visible to another portion of the diagram that is not currently visible. Any number of different techniques can be used to move between portions of a diagram. However, in general, when interacting with a canvas that exceeds the displayable area of a display device, users commonly repeat a large number of small gestures to attempt to transition back and forth between very similar states.

For example, a user can pan in a specified direction until the desired portion of a diagram moves into the displayable area. Alternately, a user can zoom out from a working zoom level (e.g., from 100% to 25%) to increase the amount of a diagram within the displayable area, select a desired portion of the diagram, and then zoom back to the working zoom level (e.g., from 25% to 100%) for a closer view of the selected portion of the diagram.

However, either of these (as well as other possible) techniques for moving within a diagram, typically require a number of manual (and typically repetitive) user input gestures. For example, to manually pan within a diagram outside the visible area, a user may need to depress and hold (e.g., a left) a mouse button and simultaneously move the mouse in a specified panning direction. After some amount of movement in the specified panning direction (e.g., when reaching the edge of a mouse pad), the mouse button is released and the mouse is moved opposite the specified panning direction. These manual input gestures can be repeated, potentially a number of times, as necessary to reach a portion of a diagram that is not currently visible.

Likewise, to manually zoom out from a working zoom level, a user can scroll a mouse wheel in specified direction (e.g., towards the user) to decrease the zoom level. Depending in the desired change in zoom level, a user may repeat the manual gesture some specified number of times. Subsequently, after the desired portion of a diagram is located, the user can then manually zoom back to the working zoom level. To do so, the use again scrolls the mouse wheel in a specified direction (e.g., away from the user) to increase the zoom level. To revert back to the working zoom level, the manual gesture can be repeated the specified number of times. Further, when performing manual scrolling operations there is always some chance that a user will undershoot or overshoot the desired zoom level.

Similar repetitive manual gestures with a keyboard may also be used to move to other portions of a diagram.

When using a mouse and/or keyboard, these and other similar manual gestures can become tedious for a user and also present a potential entry barrier for new users considering diagramming products.

### BRIEF SUMMARY

The present invention extends to methods, systems, and computer program products for smart gestures for diagram state transitions. In some embodiments, a single user input gesture is used to change the zoom state of the diagram. Some but not all of a diagram is presented on a display device at a working zoom level. A single user input gesture is received at a user input device. The single user input gesture is indicative of a user desire to transition from the working zoom level directly to a zoom level that permits the entire diagram to be presented on the display device.

In response to receiving the single user input gesture, a zoom level sufficient to display the entire diagram on the display device is calculated based on the size of the diagram. Also in response to receiving the single user input gesture, the zoom level for the diagram is transitioned from the working zoom level to the calculated zoom level. Also in response to receiving the single user input gesture, the entire diagram is presented on the display device at the calculated zoom level.

Subsequently and when appropriate, one or more additional user gestures can be received at the user input device resulting in selection of a diagram element from within the diagram. After the selection and when appropriate, a second single user input gesture can received at the user input device. The second single user input gesture is indicative of a user desire to transition from the calculated zoom level directly to the working zoom level. In response to receiving the second single user input gesture, the zoom level for the diagram is transitioned from the calculated zoom level to the working zoom level. Also, in response to receiving the second single user input gesture, the selected diagram element is presented on the display device at the working zoom level.

In some embodiments, a single user input gesture is used to change the zoom state of the diagram. Some but not all of a diagram is presented on a display device at a specified working zoom level. A user gesture selecting a diagram element from within the diagram is received at the user input device. At least part of the selected diagram element is outside the displayable area of the display device when selected. The diagram is panned to fully present the selected diagram element at the display device in response to the user gesture selecting the diagram element.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates smart gestures for diagram state transitions.

FIG. 2 illustrates a flow chart of an example method for using a single user input gesture to change the zoom state of a diagram.

FIGS. 3A-3C illustrate zooming state transitions.

FIG. 4 illustrates a flow chart of an example method for using a single user input gesture to change the pan state of a diagram.

FIGS. 5A-5C illustrate panning state transitions.

### DETAILED DESCRIPTION

The present invention extends to methods, systems, and computer program products for smart gestures for diagram state transitions. In some embodiments, a single user input gesture is used to change the zoom state of the diagram. Some but not all of a diagram is presented on a display device at a working zoom level. A single user input gesture is received at a user input device. The single user input gesture is indicative of a user desire to transition from the working zoom level directly to a zoom level that permits the entire diagram to be presented on the display device.

In response to receiving the single user input gesture, a zoom level sufficient to display the entire diagram on the display device is calculated based on the size of the diagram. Also in response to receiving the single user input gesture, the zoom level for the diagram is transitioned from the working zoom level to the calculated zoom level. Also in response to receiving the single user input gesture, the entire diagram is presented on the display device at the calculated zoom level.

Subsequently and when appropriate, one or more additional user gestures can be received at the user input device resulting in selection of a diagram element from within the diagram. After the selection and when appropriate, a second single user input gesture can received at the user input device. The second single user input gesture is indicative of a user desire to transition from the calculated zoom level directly to the working zoom level. In response to receiving the second single user input gesture, the zoom level for the diagram is transitioned from the calculated zoom level to the working zoom level. Also, in response to receiving the second single user input gesture, the selected diagram element is presented on the display device at the working zoom level.

In some embodiments, a single user input gesture is used to change the zoom state of the diagram. Some but not all of a diagram is presented on a display device at a specified working zoom level. A user gesture selecting a diagram element from within the diagram is received at the user input device. At least part of the selected diagram element is outside the displayable area of the display device when selected. The diagram is panned to fully present the selected diagram element at the display device in response to the user gesture selecting the diagram element.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Generally, embodiments of the invention expose a set of gestures and behaviors, which permit diagram transitions to be made with a reduced number of (and potentially a single) user gesture(s).

In some embodiments, a single user gesture is used to zoom out to see all the content on a canvas and then use the same gesture again to “toggle” back to a working zoom. “Zoom to all” logic can account for floating diagram elements (e.g., “tool” windows), which may otherwise occlude other content on the canvas. Accounting for floating diagram elements (such as tool windows) helps ensure that the canvas is zoomed out and positioned in an open window within available viewport space. Users can also more quickly zoom to a specific diagram element, viewing it at the working zoom level.

A working zoom level can be any desired zoom level. One user may prefer to work at 100% zoom, while another user prefers to work at 150% zoom or some other zoom level. A working zoom may be the last zoom level a user was working at before “Zoom to All” logic is executed. Working zoom can be adjusted using a user adjustable setting. Thus, a user can expressly define what zoom a working zoom is to be. In some embodiments, working zoom is between 75% and 125% zoom. However, virtually any user desired working zoom level is possible. Thus, it may also be that after returning from “Zoom to All” the zoom level is different (i.e., the expressly defined working zoom level) from the zoom level prior to execution the “Zoom to All” logic (i.e., a zoom level other than the expressly defined working zoom level).

In other embodiments, a single user gesture is used to auto-pan diagram elements into view upon selection. When selecting a diagram that is not fully in view or accessing a new diagram element, the canvas can be automatically panned so the selected or new diagram element is fully in view.

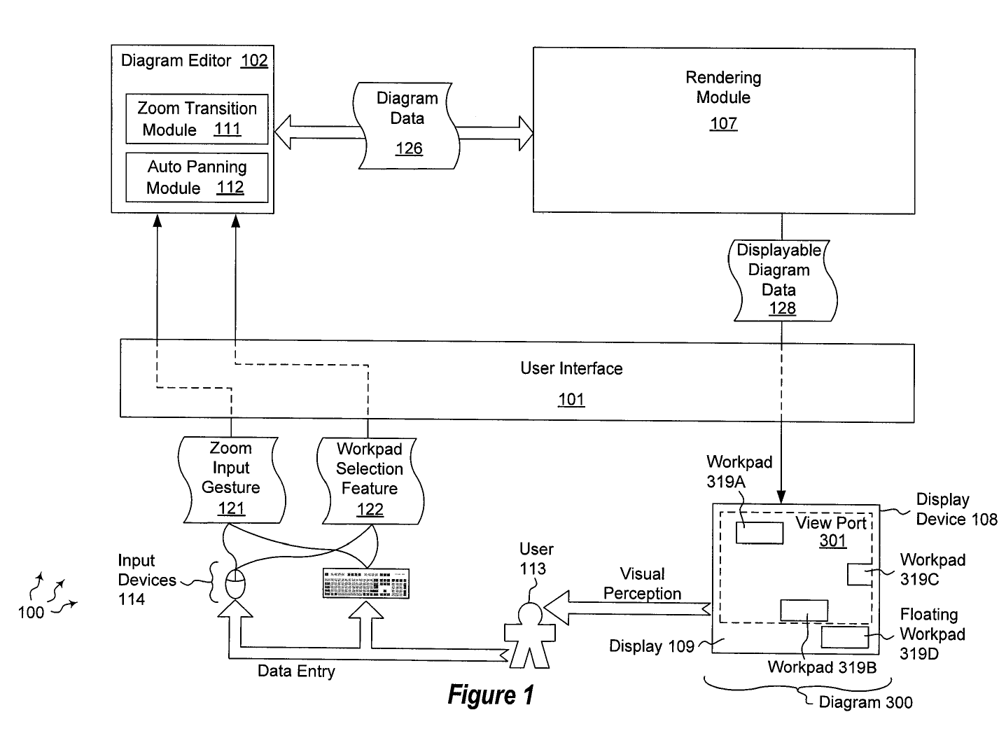

FIG. 1 illustrates an example computer architecture 100 that facilitates smart gestures for diagram state transitions. Referring to FIG. 1, computer architecture 100 includes user interface 101, diagram editor 102, rendering module 107, display device 108, and input devices 114. Each of the depicted components is connected to one another over (or is part of) a network, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Input devices 114 can include a variety of input devices, such as, for example, a keyboard and/or mouse. User 113 can utilize input devices 114 to enter data into computer architecture 100. Display device 108 can visually present data output from computer architecture 100 on display 109. User 113 can visually perceive data displayed at display 109.

Generally, user-interface 101 is configured to function as an intermediary software layer between input devices 114 and display device 108 and other (e.g., software) components of computer architecture 100. User-interface 101 can be configured with appropriate software, such as, for example, drivers, to receive input from input devices 114 and to send output to display device 108. Thus, user-interface 101 can forward user-input to other components, such as, for example, diagram editor 102. User-interface 101 can also forward renderable image data from other components, such as, for example, rendering module 107, to display device 108.

Diagram editor 102 is configured to edit diagram data for renderable diagrams. In response to user-input, diagram editor 102 can add, delete, and alter diagram data representing shapes location, shape types, and connections between shapes of a diagram. In some embodiments, one or more user gestures cause diagram editor 102 to perform a series of edits to diagram data.

As depicted, diagram editor 102 includes zoom transition module 111 and auto-panning module 112. When at a working zoom level, zoom transition module 111 is configured to edit diagram data 126 to reflect zooming from the working zoom level to see all the content on a canvas in response to a single user gesture. When all the content on the canvas is visible, zoom transition module 111 is configured to edit diagram data 126 to reflect zooming from the zoom level where all the content on the canvas is visible to the working zoom level also in response to the single user gesture. Accordingly, the single user gesture is essential a toggle for going between the working zoom level and a zoom level where all the content on the canvas is visible.

As depicted, diagram editor 102 also includes auto panning module 112. When a diagram element is selected or added, auto panning module 112 is configured to edit diagram data 126 to reflect panning the canvas so that the selected or added diagram element is completely in view.

Rendering module 107 is configured to generate (potentially interconnected) visual elements from diagram data 126 for rendering a diagram at display device 108. Rendering module 107 can use diagram data 126 as instructions for rendering visual elements to display 109. For example, rendering module 107 can generate displayable diagram data 128 from diagram data 126. Displayable diagram data 128 can be in a format that is renderable at display device 108 to present diagram 300. When appropriate, connections between visual elements can be represented as a line. Rendering module 107 and diagram editor 102 can share access to diagram data 126.

As depicted in computer architecture 100, diagram 300 is presented on display 109. View port 301 represents a working canvas area including workpads 319A, 319B, and 319C. Floating workpad 319D is outside of view port 301. As depicted, workpad 319C is not fully visible at the current zoom level. Cursor 331 represents a cursor, such as, for example, a mouse cursor.

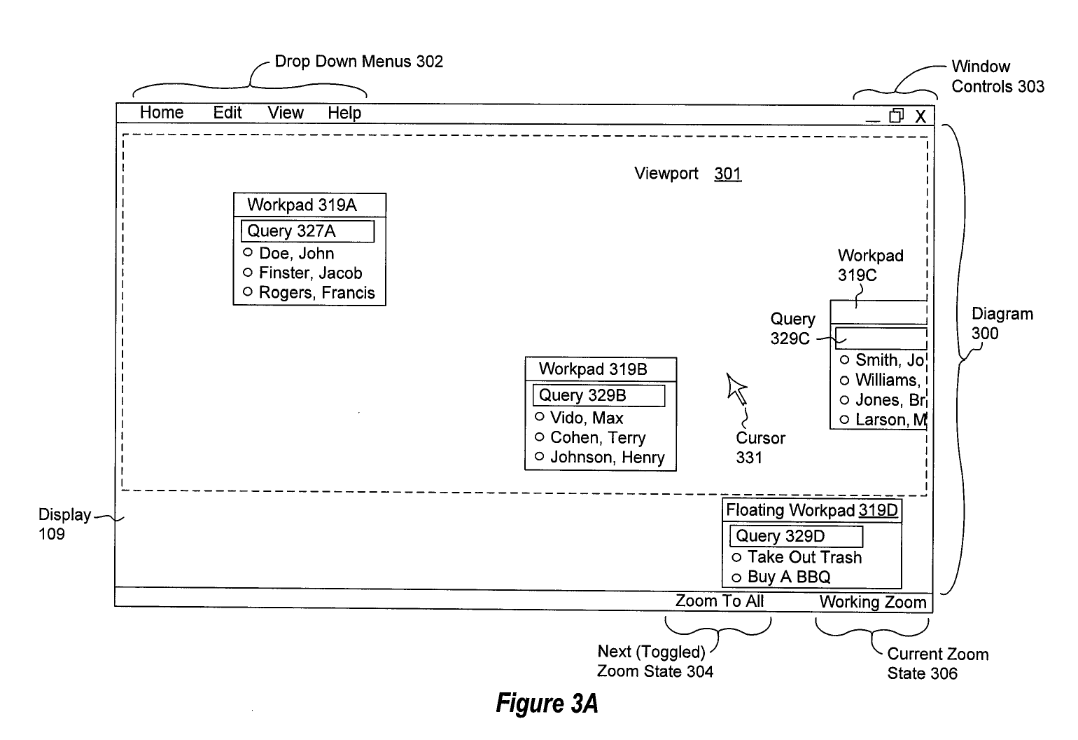

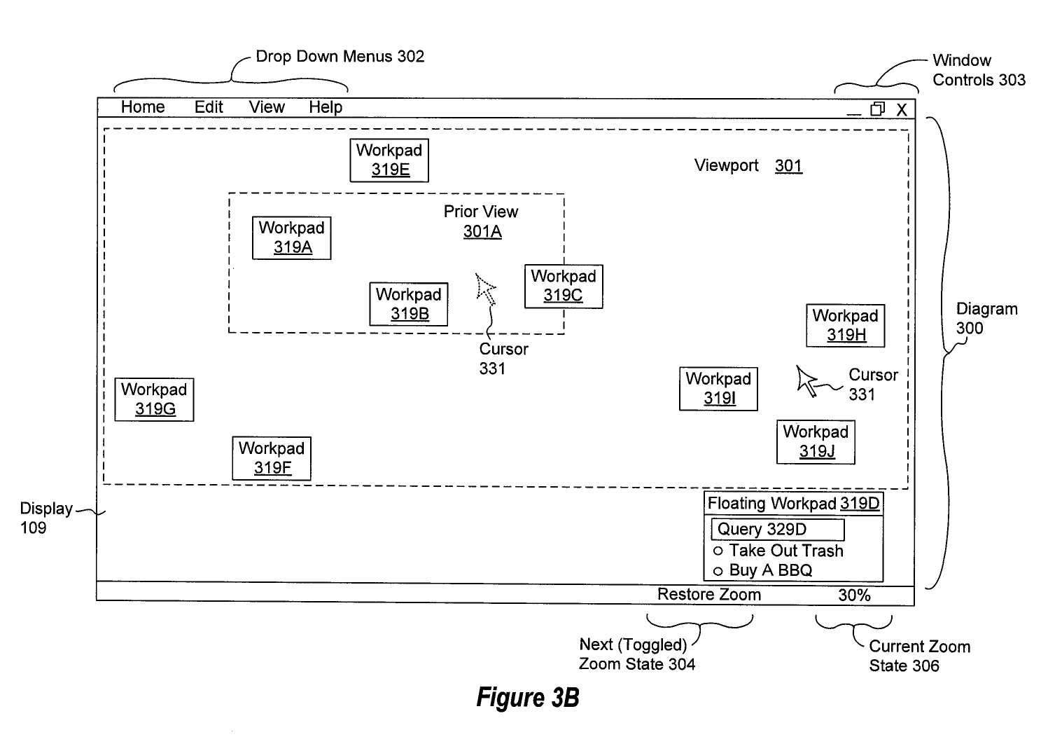

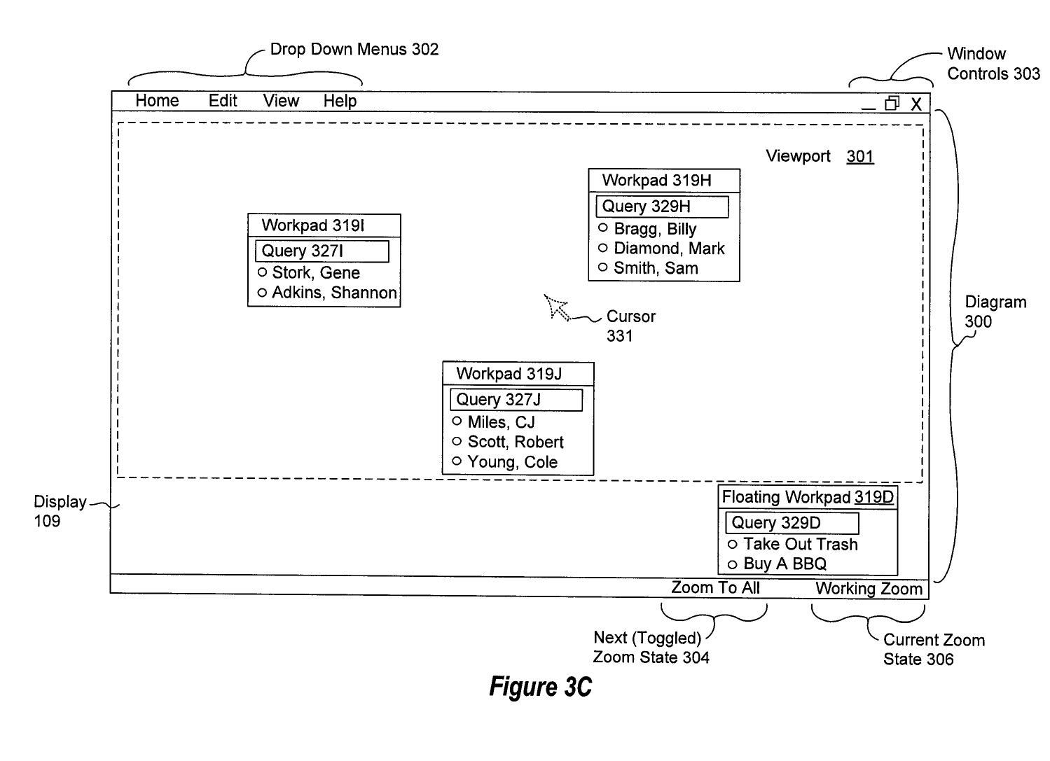

FIGS. 3A-3C illustrate zooming state transitions of diagram 300. Diagram 300 is depicted in a graphical user interface environment. Drop down menus 302 can include operations and functions that can be performed on diagram elements in diagram 300. Window controls 303 can be used to minimize, size, and close the window. As depicted in FIGS. 3A-3C, workpads 319A-319J each contain (e.g., database) data retuned from corresponding queries 329A-329J respectively.

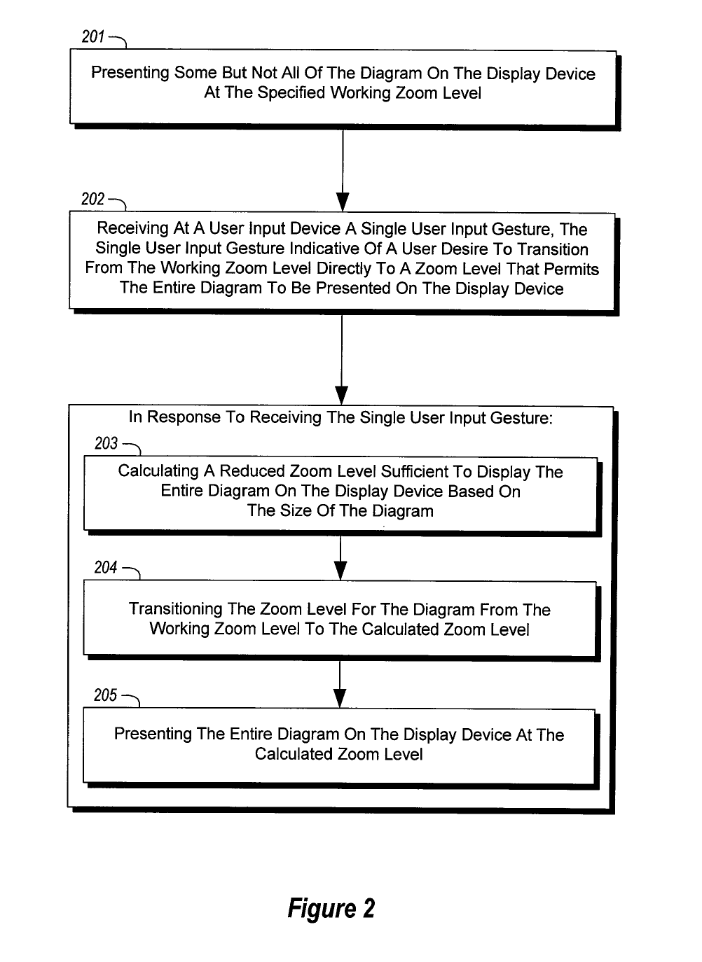

FIG. 2 illustrates a flow chart of an example method 200 for using a single user input gesture to change the zoom state of the diagram. Method 200 will be described with respect to the components and data of computer architecture 100 and the zooming state transitions of diagram 300.

Method 200 includes an act of presenting some but not all of the diagram on the display device at the specified working zoom level (act 201). For example, turning to FIG. 3A, some but not all of diagram 300 is presented on display 109. As indicated by current zoom state 306, diagram 300 is being presented at “Working Zoom” (e.g., 100% or another user desired working zoom). Workpad 319C is partially presented. Next (toggled) zoom state 304 indicates that, when activated, a zoom input gesture is to toggle the diagram to “Zoom To All”.

Method 200 includes an act of receiving at a user input device a single user input gesture, the single user input gesture indicative of a user desire to transition from the working zoom level directly to a zoom level that permits the entire diagram to be presented on the display device (act 202). For example, diagram editor 102 can receive zoom input gesture 121 from one or more of input devices 114. Zoom input gesture 121 can indicate a desire of user 113 to transition from “working zoom” directly to “zoom to all” that permits presentation of diagram 300 in its entirety on display 109. Zoom input gesture 121 can represent activation of one or buttons and/or keys on a mouse and/or a keyboard. In some embodiments, zoom input gesture 121 represents “double-clicking” on the canvas.

In response to receiving the single user input gesture, method 200 includes an act of calculating a zoom level sufficient to display the entire diagram on the display device based on the size of the diagram (act 203). For example, zoom transition module 111 can calculate a reduced zoom level sufficient to display diagram 300 in its entirety on display 109. Zoom transition module 111 can calculate the reduced zoom level based on the size of diagram 300.

The reduced zoom level can be calculated to be as large as possible, while permitting diagram 300 to be displayed in its entirety. Thus, when diagram 300 is smaller the reduced zoom size can be larger (i.e., closer to working zoom). On the other hand, when diagram 300 is larger the reduced zoom level can be smaller. For example, when diagram 300 has dimensions A×B the reduced zoom level may be 50%. On the other hand, when diagram 300 has dimensions 2A×2B the reduced zoom level may be 25%.

The existence of any floating windows can also be considered when calculating a zoom level sufficient to display the entire diagram on the display device

In response to receiving the single user input gesture, method 200 includes an act of transitioning the zoom level for the diagram from the working zoom level to the calculated zoom level (act 204). For example, zoom transition module 111 can edit diagram data 126 to zoom diagram 300 from working zoom to the calculated zoom level where diagram 300 is to be visible in its entirety.

In response to receiving the single user input gesture, method 200 includes an act of presenting the entire diagram on the display device at the calculated zoom level (act 205). For example, turning to FIG. 3B, rendering module 107 can render diagram 300 in its entirety, including workpads 319E-319J, within viewport 301 on display 109. The representation of cursor 331 in dashed lines represents the location of cursor 331 (relative to workpads 319A-319C) when zoom input gesture 121 was received. Prior view 301A indicates the prior extent of viewport 301 at working zoom. As indicated by current zoom state 306, diagram 300 is being presented at “30%” zoom. Next (toggled) zoom state 304 indicates that, when activated, the zoom input gesture is to “Restore Zoom” to its prior state (i.e., toggle back to “Working Zoom”).

Subsequent to presentation of diagram 300 in its entirety, diagram editor 102 can receive one or more additional user gestures from one or more of input devices 114. The one or more additional gestures can result in selection of another location within diagram 301 or selection of a diagram element within diagram 300. For example, the representation of cursor 331 in solid lines represents a location where user 113 has moved cursor 331.

After cursor 331 is moved (or even if the cursor remains in the same location), diagram editor 102 can again receive zoom input gesture 121. Receiving zoom input gesture 121 again can indicate a desire of user 113 to transition from “zoom to all” directly back to “working zoom”. For example, user 113 can “double click” on the canvas after cursor 331 is moved.

In response to again receiving zoom input gesture 121, zoom transition module 111 can transition the zoom level for diagram 300 from the calculated zoom level (i.e., 30%) back to the working zoom level. For example, zoom transition module 111 can edit diagram data 126 to zoom diagram 300 from “Zoom To All” to “Working Zoom” based on the current location of cursor 331 (e.g., using the location of cursor 331 as the origin).

Also in response to again receiving zoom input gesture 121, rendering module 107 can presented the selected portion of diagram 300 in display device 300 at the working zoom level. For example, turning to FIG. 3C, rendering module 107 can render a portion of diagram 300, including workpads 319H-319J, in viewport 301. The representation of cursor 331 in dashed lines represents the location of cursor 331 (relative to workpads 319H-319J) when zoom input gesture 121 was again received. As indicated by current zoom state 306, diagram 300 is being presented at “Working Zoom” (e.g., 100% or another user desired working zoom). Next (toggled) zoom state 304 indicates that, when activated, a zoom input gesture is to toggle the diagram to “Zoom To All”.

As depicted, in FIGS. 3A-3C floating workpad 319D remains outside of viewport 301. As such, there is little, if any, chance that floating workpad 319D may occlude the view of other diagram elements within viewport 301.

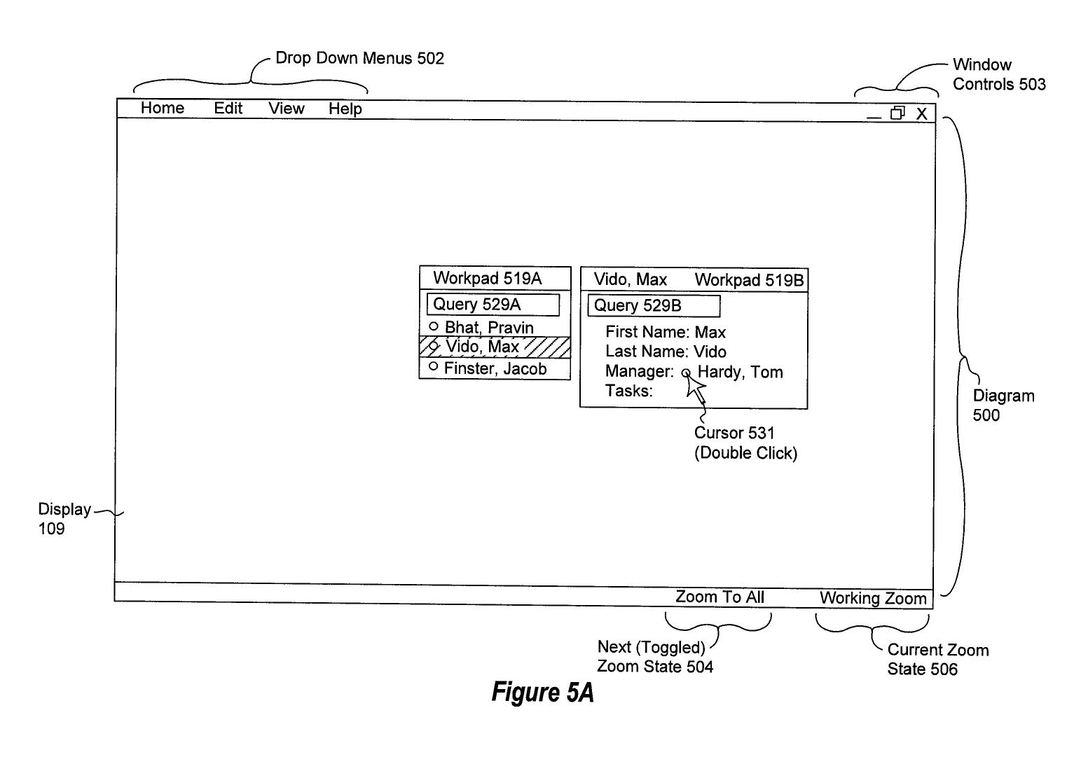

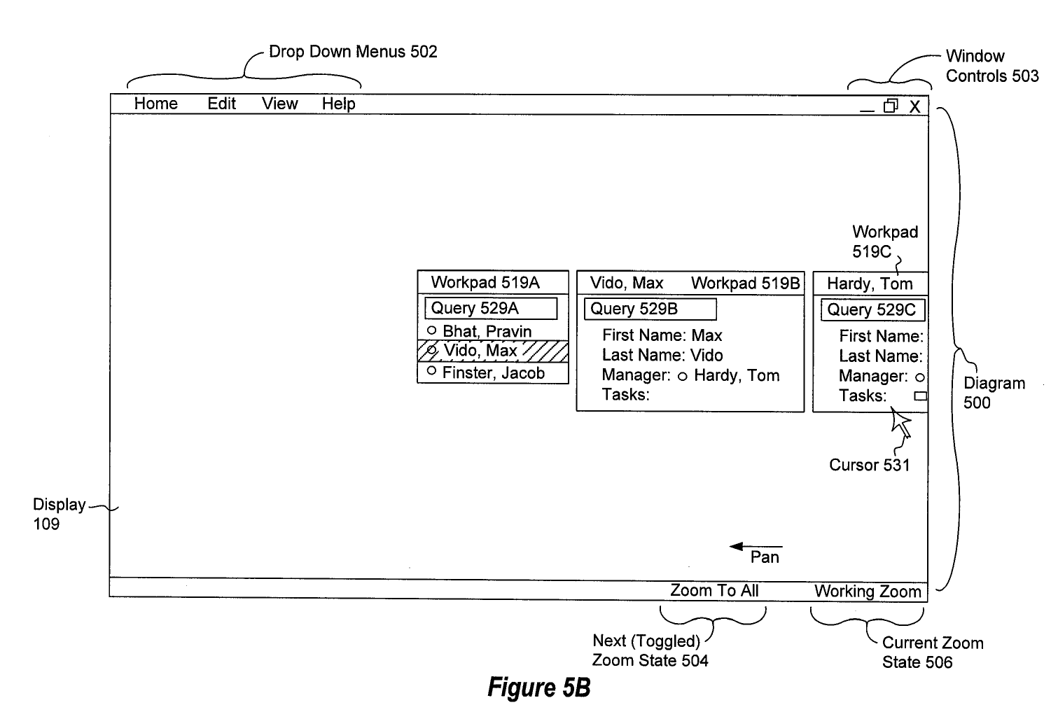

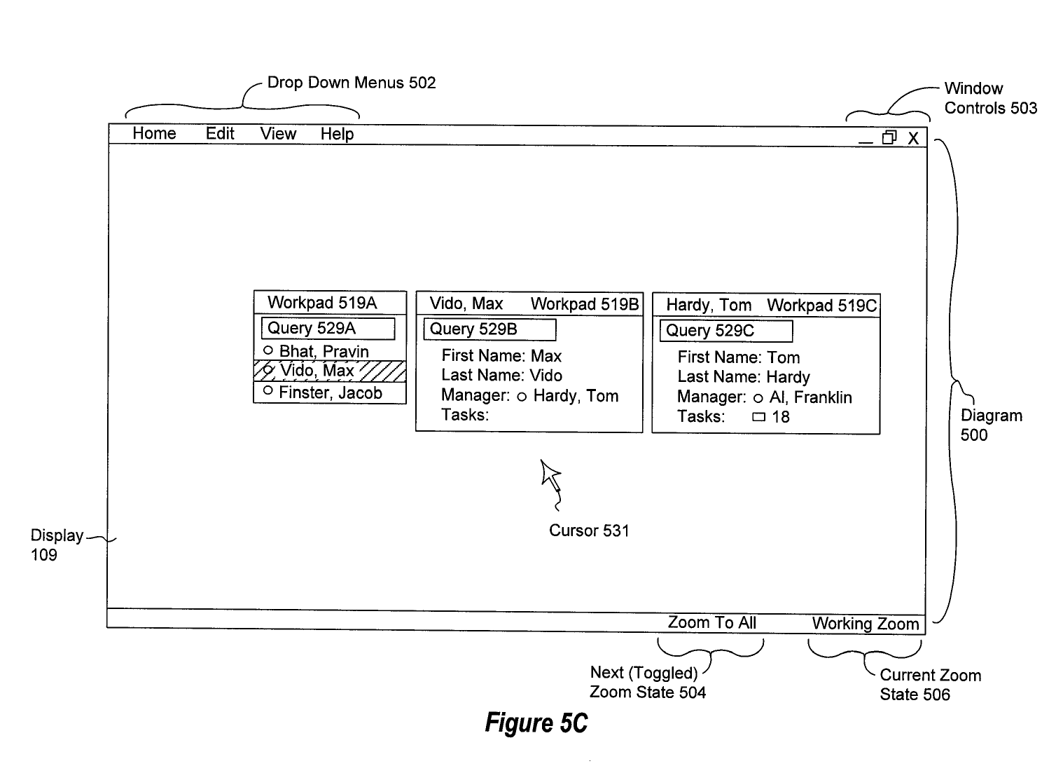

FIGS. 5A-5C illustrate panning state transitions of diagram 500. Diagram 500 is depicted in a graphical user interface environment. Drop down menus 502 can include operations and functions that can be performed on diagram elements in diagram 500. Window controls 503 can be used to minimize, size, and close the window. As depicted in FIGS. 5A-5C, workpads 519A-519C each contain (e.g., database) data retuned from corresponding queries 529A-529C respectively.

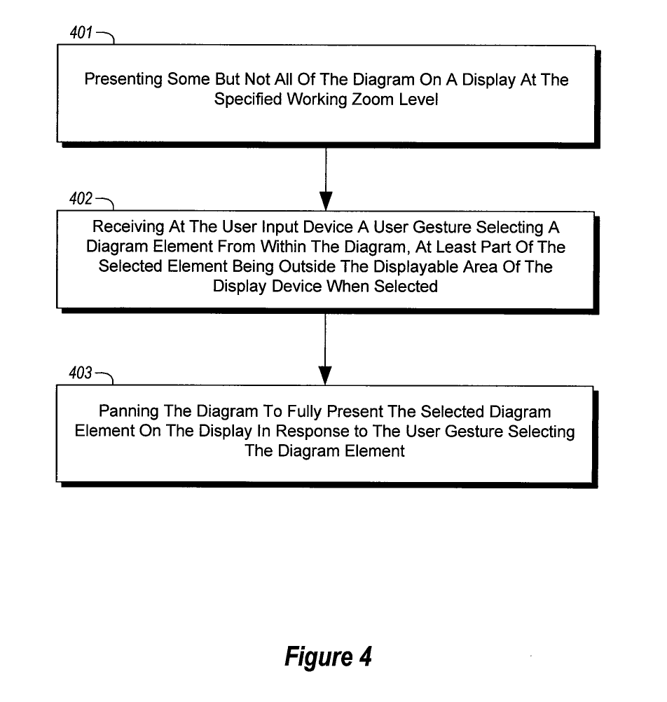

FIG. 4 illustrates a flow chart of an example method 400 for using a single user input gesture to change the pan state of the diagram. Method 400 will be described with respect to the components and data of computer architecture 100 and the zooming state transitions of diagram 400.

As depicted in FIG. 5A, workpads 519A and 519B are entirely visible on display 109. User 113 can move cursor 531 as positioned in FIG. 5A. User 113 can then double click on the selection box next to “Hardy, Tom”.

Method 400 includes an act of presenting some but not all of the diagram on a display at the specified working zoom level (act 401). For example, turning to FIG. 5B, in response to double clicking, workpad 519C is created and partially presented on display 109. However, at least part of workpad 519C is outside the displayable area of display 109. As such, some but not all of diagram 500 is presented on display 109 after workpad 519C is created. Current zoom state 506 indicates that the current zoom level of diagram 500 is “Working Zoom”. Next (toggled) zoom state 304 indicates that, when activated, a zoom input gesture is to toggle the diagram to “Zoom To All”.

Method 400 includes an act of receiving at the user input device a user gesture selecting a diagram element from within the diagram, at least part of the selected diagram element being outside the displayable area of the display device when selected (act 402). For example, diagram editor 102 can receive workpad selection gesture 122 from input devices 114. In FIG. 5B, this can include positioning cursor 531 over a visible portion of workpad 519C and “clicking” on workpad 519C.

Method 400 includes an act of panning the diagram to fully present the selected diagram element on the display in response to the user gesture selecting the diagram element (act 403). For example, auto panning module 112 can edit diagram data 126 to pan diagram 500 sufficiently to the left so that workpad 519C is fully presented on display 109. Rendering module 107 can then render diagram 500 as depicted in FIG. 5C, with workpad 519C fully presented.

In some embodiments, acts 402 and 403 are collapsed into an automated panning state transition. For example, upon creation of workpad 519C, auto panning module 112 can automatically determine that workpad 519C is not entirely visible on display 109. In response (and without further user input), auto panning module 112 can automatically pan diagram 500 to the state depicted in FIG. 5C. Accordingly, workpad 519C automatically pans into view upon creation. As such, user 113 is relieved from having to manually select workpad 519C to trigger the panning state transition.

Accordingly, embodiments of the invention reduce the need for users to repeatedly (and often tediously) enter a number of smaller gestures to implement state transitions. State transitions can be implemented using a reduced number of (and potentially only one) user input gesture(s). For example, zoom levels can be toggled between a working zoom level and a zoom level sufficient to present an entire diagram and vice versa using a single user input gesture. Likewise, diagrams can be appropriately panned to make selected as well as newly created diagram elements visible in their entirety using a single user input gesture.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including a display device and a user input device, the display device displaying a portion of a diagram at a specified working zoom level, the specified working zoom level preventing all of the diagram from being simultaneously presented at the display device, a method for using a single user input gesture to change the zoom state of the diagram, the method comprising:
an act of presenting some but not all of the diagram on the display device at the specified working zoom level;
an act of receiving at the user input device a single user input gesture, the single user input gesture indicative of a user desire to transition from the working zoom level directly to a zoom level that permits the entire diagram to be presented on the display device;
in response to receiving the single user input gesture:
an act of calculating a reduced zoom level sufficient to display the entire diagram on the display device based on the size of the diagram;
an act of transitioning the zoom level for the diagram from the working zoom level to the calculated zoom level; and
an act of presenting the entire diagram on the display device at the calculated zoom level.

2. The method as recited in claim 1, further comprising after presenting the entire diagram on the display device an act of receiving at the user input device one or more additional user gestures indicating selection of a different part of the diagram.

3. The method as recited in claim 2, wherein receiving at the user input device one or more additional user gestures indicating selection of a different part of the diagram comprises receive one or more one or more additional user gestures resulting in selection of a diagram element from within the diagram.

4. The method as recited in claim 3, further comprising after selection of the diagram element:
an act of receiving at the user input device a second single user input gesture, the second single user input gesture indicative of a user desire to transition from the calculated zoom level directly to the working zoom level;
in response to receiving the second single user input gesture:
an act of transitioning the zoom level for the diagram from the calculated zoom level to the working zoom level; and
an act of presenting the selected diagram element on the display device at the working zoom level.

5. The method as recited in claim 4, wherein the act of receiving at the user input device a second single user input gesture comprises an act of receiving a double click from a mouse.

6. The method as recited in claim 4, further comprising an act of indicating on the display along with the diagram that the current zoom level is the working zoom level.

7. The method as recited in claim 1, wherein the act of presenting some but not all of the diagram on the display device at the specified working zoom level comprises an act of presenting less than all of at least one workpad.

8. The method as recited in claim 1, wherein the act of presenting some but not all of the diagram on the display device at the specified working zoom level comprises an act of presenting some but not all of the diagram on the display device at the specified working zoom level, wherein the working zoom level is between 75% zoom and 125% zoom.

9. The method as recited in claim 1, wherein the act of receiving at the user input device a single user input gesture comprises an act of receiving a double click from a mouse.

10. The method as recited in claim 1, wherein the act of calculating a reduced zoom level sufficient to display the entire diagram on the display device comprises an act of calculating reduced zoom level sufficient to display the entire diagram on a view port, where the view port size is less than the full display of the display device due to one or more floating workpads.

11. The method as recited in claim 1, further comprising an act of indicating on the display that the current zoom level is reduced so that the entire diagram is visible.

12. At a computer system including a display device and a user input device, the display device displaying a portion of a diagram at a zoom level, the zoom level preventing all of the diagram from being simultaneously presented at the display device, a method a method for using a single user input gesture to change the pan state of the diagram, the method comprising:
an act of presenting some but not all of the diagram on the display at the specified working zoom level;
an act of receiving at the user input device a user gesture selecting a diagram element from within the diagram, at least part of the selected diagram element being outside the displayable area of the display device when selected; and
an act of panning the diagram to fully present the selected diagram element at the display device in response to the user gesture selecting the diagram element.

13. The method as recited in claim 12, wherein the act of presenting some but not all of the diagram on the display device at the specified working zoom level comprises an act of detecting that a portion of a workpad is visible and another portion of the workpad is not visible.

14. The method as recited in claim 13, wherein an act of receiving at the user input device a user gesture selecting a diagram element from within the diagram comprise an act of receiving user input selecting part of workpad that is visible.

15. The method as recited in claim 14, wherein the act of panning the diagram to fully present the selected diagram element at the display device in response to the user gesture selecting the diagram element comprises an act of panning the diagram so that the portion of the workpad that is not visible becomes visible in response to selecting the portion of the workpad that is visible.

16. The method as recited in claim 12, wherein the act of presenting some but not all of the diagram on the display device at the specified working zoom level comprises an act of creating a new workpad that is not fully visible on the display.

17. The method as recited in claim 16, wherein an act of receiving at the user input device a user gesture selecting a diagram element from within the diagram comprises an act of prior to presenting some but not all of the diagram selecting a portion of an existing workpad to cause the new workpad to be created.

18. A computer system, the computer system comprising:
system memory;
one or more processors;
a display device, the display device configured to display diagrams;
a user input device, the user input device configured to receive input gestures indicative of a user desire to alter the state of diagrams displayed on the display device; and
one more computer storage media having stored thereon computer-executable instructions representing a diagramming module, the diagramming module configured to provide displayable diagram data to the display device, the diagramming module including a zoom transition module and an auto-panning module, the zoom transition module configured to:
receive an indication of a single user input gesture representing a user desire to transition from a working zoom level directly to a zoom level that permits an entire diagram to be presented on the display device; and
in response to the single user input gesture:
calculate a zoom level sufficient to display the entire diagram on the display device based on the size of the diagram;
transitioning the zoom level for the diagram from the working zoom level to the calculated zoom level; and
provide displayable diagram data for presenting the entire diagram on the display device at the calculated zoom level;
wherein the zoom transition module is also configured to:
receive an indication of a second single user input gesture representing a user desire to transition from the calculated zoom level directly to the working zoom level; and
in response to the second single user input gesture:
transition the zoom level for the diagram from the calculated zoom level to the working zoom level; and
provide displayable diagram data for presenting a first selected diagram element on the display device at the working zoom level; and
wherein the auto panning module is configured to:
receive an indication of a third single user input gesture selecting a second diagram element from within the diagram, at least part of the selected second diagram element being outside the displayable area of the display device when selected; and
provide displayable diagram data for panning the diagram to fully present the selected second diagram element at the display device in response to the third single user gesture selecting the diagram element.

19. The computer system as recited in claim 18, wherein the system is further configured to indicate the current zoom state and the next zoom state of the diagram along with the diagram on the display.

20. The computer system as recited in claim 18, wherein the diagram elements are workpads contained data from a database.
